(19) United States
(12) Patent Application Publication
(10) Pub. No.: US 2007/0080485 A1
(43) Pub. Date: Apr. 12, 2007

(54) Film and methods of making film

(76) Inventors: Christopher S. Kerscher, Greenville, SC (US); Jiannong Xu, Spartanburg, SC (US)

Correspondence Address: John E. Vick, Jr.;Legal Department, M-495, P.O. Box 1926, Spartanburg, SC, 29304, US

(21) Appl. No.: 11/496,989

(22) Filed: Aug. 1, 2006

Related U.S. Application Data
(60) Provisional application No. 60/724,626, filed on Oct. 7, 2005.

(51) Int. Cl. C08K 5/09; B29C 55/28; B29C 55/06

(52) U.S. Cl. 264/564; 524/394; 524/493; 264/211; 264/210.6

(57) ABSTRACT

Employment of cycloaliphatic salt nucleating agent additives in thermoplastics or polyolefins such as polypropylene may improve the properties of a manufactured film. Furthermore, co-additives used with the cycloaliphatic salts, such as fatty acid salts, also may improve the film properties in terms of physical properties and haze of the resulting film. Fatty acid salts may include stearates with metal ion salts, such as zinc, calcium, lithium, magnesium or sodium.

### CROSS REFERENCE TO RELATED APPLICATIONS

This application claims priority to previous U.S. Application Ser. No. 60/724,626 (Milliken File 5957) which was filed on Oct. 7, 2005.

### BACKGROUND OF THE INVENTION

Polymer compositions may be rendered molten for manufacture into a wide variety of articles. Such articles may include films, fibers, and tubes. Various polymer processing techniques are known, including extrusion, blowing, molding, compression, and injection, in which the molten polymer is cooled and shaped into a solid mass. Each process has its own particular physical and chemical effects upon the polymer. Further, each process is customized to achieve exactly the performance required from the polymer, using the least amount of energy, and at the maximum rate of production. In general, the use of one compound or formula in one type of polymer processing technique does not predict success using the same formula in another type of processing technique. Extensive trial and experimentation is needed to determine that a particular formulation is or is not suitable for a particular type of polymer process.

Thermoplastic compositions must exhibit certain physical characteristics to facilitate widespread use. Specifically within polyolefins, for example, uniformity in arrangement of crystals upon crystallization is sometimes necessary to provide an effective, durable, and versatile polyolefin article. To achieve desirable physical properties, certain compounds and compositions can be employed to provide nucleation sites for polyolefin crystal growth during molding or fabrication. Nucleating agents are known to modify the crystalline structure of thermoplastic polymers.

The use of nucleating agents may increase the temperature and the rate of crystallization. Compositions containing such nucleating compounds crystallize at a much faster rate than non-nucleated polyolefins. Crystallization at higher temperatures results in reduced fabrication cycle times and a variety of improvements in physical properties such as stiffness.

Nucleating agents provide nucleation sites for crystal growth during cooling of a thermoplastic molten formulation. The presence of such nucleation sites results in a larger number of smaller crystals. As a result of the smaller crystals formed therein, clarification of the target thermoplastic may be achieved. However, excellent clarity is not always a result. The more uniform (and smaller) the crystal size, the less light is scattered. Thus, the clarity of the thermoplastic article itself may be improved. Thus, thermoplastic nucleator compounds are important to the industry, as they may provide enhanced clarity, improved physical properties and faster processing.

Dibenzylidene sorbitol derivatives are nucleator compounds, commonly used in polypropylene end-products. Compounds such as 1,3-O-2,4-bis(3,4-dimethylbenzylidene) sorbitol (hereinafter “DMDBS” or “Millad® 3988”), available from Milliken & Company under the trade name Millad® 3988, provide nucleation and clarification characteristics for polypropylene.

One nucleating agent marketed by Milliken & Company is known as HYPERFORM®, or HPN-68™, as shown in U. S. Pat. No. 6,465,551. This product, which comprises a dicarboxylate salt, is commonly known as “hyper” nucleating agent. It is commonly used in injection molded polypropylene. Other well known nucleator compounds include sodium benzoate, sodium 2,2′-methylene-bis-(4,6-di-tert-butylphenyl) phosphate (from Asahi Denka Kogyo K. K., known as “NA-11™”), aluminum bis[2,2′-methylene-bis-(4,6-di-tert-butylphenyl)phosphate] (also from Asahi Denka Kogyo K. K., known as “NA-21™”), and talc.

U.S. Pat. Nos. 6,599,971 and 6,562,890 each disclose using metal salts of hexahydrophthalic acid (HHPA) in injection molded polypropylene (PP) to provide desirable properties to injection molded articles. U.S. Pat. No. 6,562,890 teaches, for example, the extrusion of disodium HHPA salts with calcium stearate in polypropylene homopolymer in an extrusion process. Extrusion of polypropylene is followed by injection molding, to form polypropylene 50 mil PP plaques. A Killion single screw extruder is used in the process. The polypropylene is passed through an extruder die, according to the examples of the reference. Lithium stearate was used as an acid scavenger in some polypropylene samples which were passed through an extruder die in the disclosed extrusion process.

U.S. Pat. No. 6,599,971 discloses certain specific HHPA compounds used in polypropylene (PP) homopolymer and injection molded into plaques by melt compounding on a Killion single screw extruder through an extruder die. The performance of various HHPA compounds were measured in injection molded polypropylene plaques as stated in the reference. Acid scavengers such as calcium stearate and lithium stearate are disclosed. This patent discloses the nucleation of polyesters.

Extrusion of polymer is a common manner of making extruded plastic articles. Other processes, however, are known for processing polymers. Processing techniques, temperatures, and the like vary greatly among various types of polymer processing techniques. In general, it is not predictable or certain that any particular formulation used in one type of processing (such as extrusion) could apply or work in a different type of polymer processing technique, using different temperatures, mechanical processing methods, cure times and the like. Further, each type of polymer itself provides unique properties, and it is not predictable that an additive or procedure used with one type of polymer would perform satisfactorily with another polymer.

### BRIEF DESCRIPTION OF THE DRAWINGS

A full and enabling disclosure of this invention, including the best mode shown to one of ordinary skill in the art, is set forth in this specification.

FIG. 1 is a schematic showing a blown film extrusion process as may be applied in the invention;

FIG. 2 shows a cast film process, as further described herein.

FIG. 3 shows a tenter process used to make biaxially oriented film, BOPP for example, as further described herein;

FIG. 4 shows a double bubble process to make oriented film;

FIG. 5 shows the effect of various additives on stiffness and impact balance in BOPP.

### DETAILED DESCRIPTION OF THE INVENTION

Reference now will be made to the embodiments of the invention, one or more examples of which are set forth below. Each example is provided by way of explanation of the invention, not as a limitation of the invention. In fact, it will be apparent to those skilled in the art that various modifications and variations can be made in this invention without departing from the scope or spirit of the invention.

Polyproplyene film is one type of film that finds particular application in the industry. In the past, biaxial orientation of polypropylene was needed to achieve the best optical properties in a polypropylene film. It is desirable in the film industry to manufacture films in a variety of ways while improving the haze and optical clarity of such blown films. This invention is directed at improved polypropylene film, and methods of making improved polypropylene-based films, such as Blowing, Casting, Orienting, and Water Quenching.

It has been discovered that employment of certain additives in polypropylene with particular cycloaliphatic salt nucleating agents may improve the properties of a film made with such polypropylene. Use of fatty acid salts as co-additives with such nucleating agents provides benefits in the manufacture of film. Such fatty acid salts may include stearates of zinc, calcium, lithium, magnesium or sodium. Zinc stearates may be particularly advantageous in the practice of the invention. In the invention, an additive package comprising at least one cycloaliphatic salt nucleating agent with a co-additive of a fatty acid salt (with a C₁₂-C₂₂ anion and a cation) is employed. The cation may be zinc, calcium, sodium, lithium, magnesium and others employed in the fatty acid salt.

When using a nucleator of a cycloaliphatic salt, a hexahydrophthalic acid (HHPA) salt compound may be employed in one particular embodiment of the invention. This compound employs a counter-ion, including, for example, a calcium counter-ion. Calcium has been found to be particularly effective in providing a low degree of haze, as compared to other counter-ions, when employed with a co-additive fatty acid salt.

A combination of a fatty acid salt of a C₁₂-C₂₂ anion and a cation of certain specific metals may provide enhanced clarity and reduced % haze. Metals of zinc, calcium, sodium, lithium, magnesium and others may be used in such a fatty acid salt. Results with zinc have been found to be particularly good. A calcium-containing nucleating agent compound and zinc stearate co-additive has been found to provide very favorable properties in blown film. Such films provide reduced % haze, while maintaining and in some instances even enhancing physical properties of the film. Calcium hexahydrophthalic acid salt (“Ca HHPA”), when used in a film, has been found to provide remarkable properties of higher nucleation density, stronger polypropylene orientation, low haze values for the film, all of which are desirable.

Definitions

1. “Cycloaliphatic metal salt” refers to a compound having a non-aromatic cyclic, or bicyclic, carbon ring structure and a metal ion as a counter ion, together forming an ionic salt compound.

2. “Polypropylene polymer or copolymer” refers to essentially any type of polypropylene (“PP”), including (for example) Ziegler Natta and/or metallocene catalyzed polypropylenes, isotactic or syndiotactic, polypropylene homopolymer or random co-polymer polypropylene and others, as described herein.

3. “Film” for purposes of this specification refers to an article made by, but not limited to: blown, cast, orientation, water-quenched, lamination or coating processes. The typical thicknesses of films made in the film making processes are 300 micron or less, and in some instances, 100 microns or less. In some instances, films of about 50 microns or less are employed.

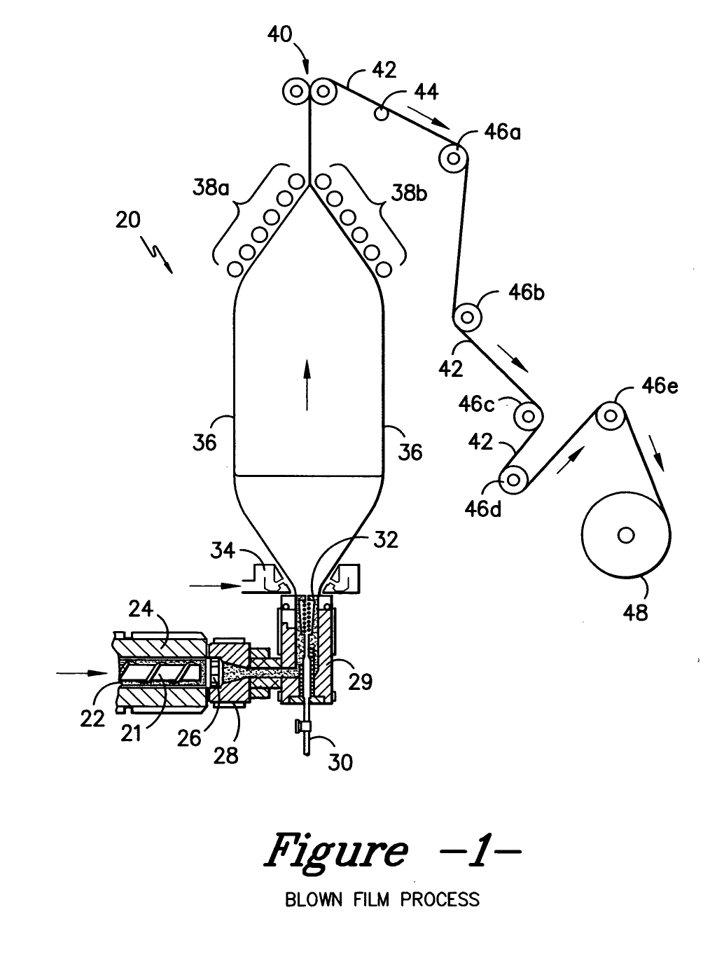

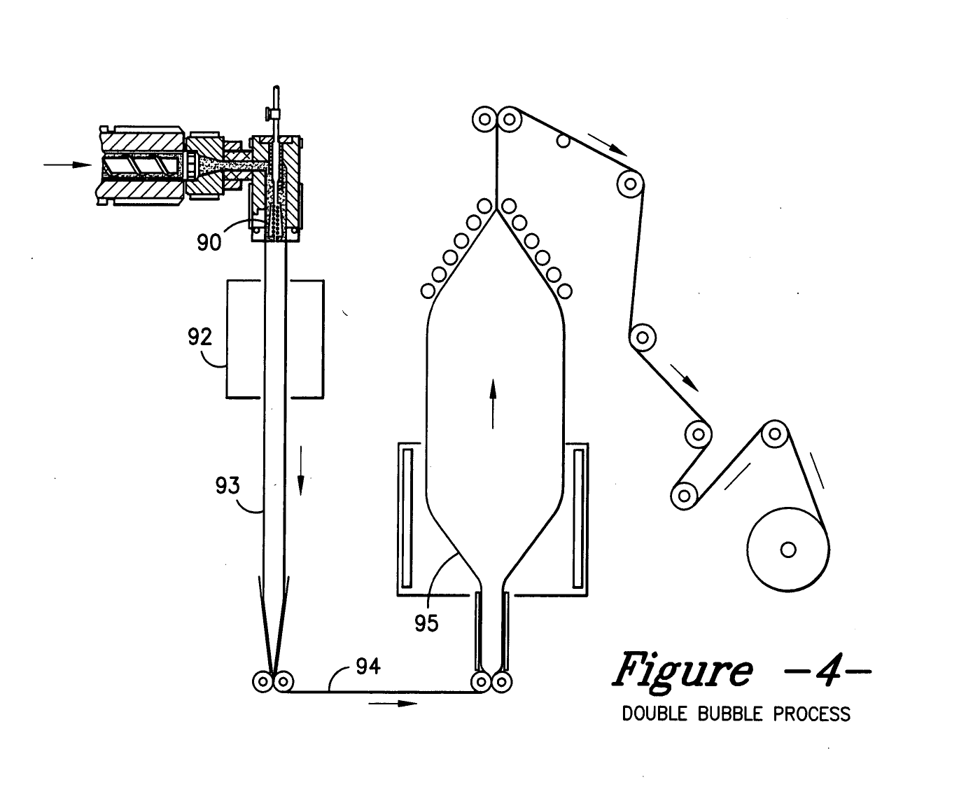

4. The term “blown film” refers to a film made according to the process shown and described in connection with FIG. 1 and related discussion. It may also include processes termed in the industry as “double bubble” processes (as shown in FIG. 4), and further described herein.
5. The term “dicarboxylate” refers to an organic metal salt that is derived from a dicarboxylic acid; that is, a compound having two carboxylic acid entities on the molecule. This may include, but is not limited to, the following illustrative example, in which the carbons of complete ring shown on the left side may be substituted, or unsubstituted: 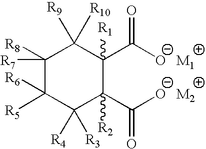
wherein M₁ and M₂ are independently selected from calcium, sodium, strontium, lithium, zinc, magnesium, and monobasic aluminum; wherein R₁, R₂, R₃, R₄, R₅, R₆, R₇, R₈, R₉, and R₁₀ are independently selected from the group consisting of: hydrogen and C₁-C₉ alkyls; further wherein any two adjacently positioned R₃-R₁₀ alkyl groups optionally may be combined to form a carbocyclic ring. In this application of the invention, it is possible, but not required, that each of R₁, R₂, R₃, R₄, R₅, R₆, R₇, R₈, R₉, and R₁₀ comprise hydrogen. Further, M₁ and M₂ may be combined as a single calcium.
6. The term “thermoplastic” is intended to mean a polymeric material that will melt upon exposure to sufficient heat and will subsequently solidify upon sufficient cooling. This term can include both semi-crystalline and amorphous polymers. Particular types of polymers contemplated within such a definition that may be applied in the practice of the invention include, without limitation, polyolefins (such as polyethylene, polypropylene, (syndiotactic or isotactic) polybutylene, and any combination thereof), polyamides (such as nylon), polyurethanes, polyesters (such as polyethylene terephthalate), copolymers of said polymers, and the like, as well as any combinations thereof.

### Further Properties of the Enhanced Film of the Invention

Improvements in optics and physical properties made possible by the invention may lead to enhancements in packaging operations and packaging performance. For example, improved modulus and stiffness is a desired property in packaging operations, as it enhances the speed and quality of the operation. Improved optics of the package are desired to improve the shelf appeal of the film or package. Improved optics are desired without the loss of other physical properties. Packaging operations that may benefit from the improved physical properties practiced in the invention include, but are not limited to Horizontal Form Fill and Seal, Vertical Form Fill and Seal, Bag Making, Film Wrapping Operations, Forming Films, lidstocks, and pouches. Multi-layer constructions may also benefit from the use of this invention.

The invention in one application employs the addition of cycloaliphatic metal salts with a polypropylene polymer or copolymer to form films having improved properties. In one particular embodiment of the invention, the fatty acid salt comprises an anion and a cation, the anion of the fatty acid salt comprising at least one C₁₈ (stearic) hydrocarbon chain.

In other more specific embodiments of the invention, it may be possible to use various hexahydrophthalate (HPPA) salt compounds as nucleating agents in such film articles. Below is the structure referred to herein as “Ca HHPA”:

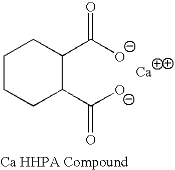

A blown film article further may comprise or include a C₁₂-C₂₂ fatty acid compound, such as for example, a stearate-type compound or a carbon chain salt, having a chain of the length indicated. Furthermore, the cycloaliphatic metal salts may comprise dicarboxylate salts, as above, including a carbocyclic ring structure, and a cation or metal.

A blown film may be made which is less than about 300 microns in thickness. In other applications, a film may be made which is less than about 100 microns in thickness, or in some instances, less than about 25 microns. A blown film article is particularly useful in the practice of the invention, but other types of film manufacturing processes also can be employed—blown, cast, biaxially oriented, water quenched, and/or lamination, as disclosed herein.

In one application of the invention, a film is made comprising a polypropylene polymer or copolymer and a cycloaliphatic metal salt, wherein said cycloaliphatic salt further comprises a compound conforming to Formula (I) 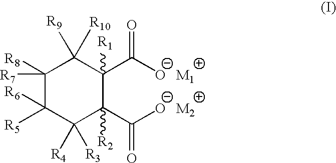
wherein M₁ and M₂ are independently selected from calcium, sodium, strontium, lithium, zinc, magnesium, and monobasic aluminum; wherein R₁, R₂, R₃, R₄, R₅, R₆, R₇, R₈, R₉, and R₁₀ are independently selected from the group consisting of: hydrogen and C₁-C₉ alkyls; further wherein any two adjacently positioned R₃-R₁₀ alkyl groups optionally may be combined to form a carbocyclic ring. In this application of the invention, it is possible, but not required, that each of R₁, R₂, R₃, R₄, R₅, R₆, R₇, R₈, R₉, and R₁₀ comprise hydrogen. Further, M₁ and M₂ may be combined as a single calcium ion.

One method of practicing the invention may comprise the steps of: (a) providing a polypropylene polymer or copolymer; (b) blending said polypropylene polymer or copolymer with a cycloaliphatic metal salt to form blended polypropylene material; (c) extruding said blended polypropylene material; and (d) forming a film.

In the practice of the invention, films can be made by several different means: blown, cast, oriented, water-quenched and be either monolayer or co-extruded films, having polypropylene as the only component or as one of many components in the monolayer or co-extruded film.

An acid scavenger compound may be applied in the method prior to the blowing step. An acid scavenger compound employed in such a method may comprise essentially any fatty acid salt, including for example a stearate, such as for example zinc stearate. Zinc stearate has been shown to provide surprisingly beneficial results, as shown in examples herein. In other cases, a silica compound may be added. This may provide advantageous characteristics to the polymer. An average particle size for the silica of less than about 1 micrometer may provide benefits. Further, in yet another embodiment, a film may be formed, the film having a thickness of about 100 micrometers or less in thickness.

In the method, one may employ a dicarboxylate salt comprising one or two cations, at least one of said cations being calcium. Calcium HHPA compounds, for example, have been found to be particularly good in this application. Also, CaHHPA compounds, when combined with a stearate, are particularly useful. When combined with a zinc stearate, excellent results may be achieved in terms of polymer properties and haze or resulting articles.

Compounds and compositions comprising specific metal salts of hexahydrophthalic acid (HHPA) in order to provide highly desirable properties within thermoplastic articles are provided. The inventive HHPA derivatives are useful as nucleating and/or clarifying agents for such thermoplastics, are practical and easy to handle. Such compounds, when added to the thermoplastic provide good (and sometimes excellent) crystallization temperatures, stiffness, and acid scavenger compatibility. A film is disclosed of a polypropylene and a cycloaliphatic metal salt, the salt having the structure shown below: 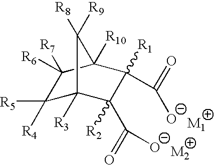
wherein M₁ and M₂ are independently selected from the group consisting of: sodium, calcium, strontium, lithium, zinc, magnesium, and monobasic aluminum; wherein R₁, R₂, R₃, R₄, R₅, R₆, R₇, R₈, R₉, and R₁₀ are independently selected from the group consisting of: hydrogen and C₁-C₉ alkyls; and
further wherein any two adjacently positioned R₃-R₁₀ alkyl groups optionally may be combined to form a carbocyclic ring. A cycloaliphatic metal salt of sodium, bicycle [2.2.1]heptane dicarboxylate can be used, and is particularly useful at a concentration level of less than about 2000 ppm. A film also is disclosed having a cycloaliphatic salt, the salt being of the compound of sodium, bicyclo[2.2.1]heptane dicarboxylate, as shown:

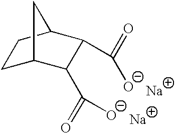

The term “polyolefin” or “polyolefin resin” as used herein is intended to encompass any materials comprised of at least one semicrystalline polyolefin. Examples include isotactic and syndiotactic polypropylene, polyethylene, poly(4-methyl)pentene, polybutylene, and any blends or copolymers thereof, whether high or low density in composition. The polyolefin polymers of the present invention may include aliphatic polyolefins and copolymers made from at least one aliphatic olefin and one or more ethylenically unsaturated co-monomers.

### Synthesis and Performance of Cycloaliphatic Metal Salts

In the practice of the invention, it is possible to make the cycloaliphatic salts that may be applied in the invention, according to the synthesis procedure set forth in U.S. Pat. No. 6,562,890 (column 7, Examples 1 and 2). Calcium HHPA (or other HHPA's) can be made in a manner similar to that shown in U.S. Pat. No. 6,562,890 for Cis-disodium HHPA, as recognized by a person of skill in the art. CaHHPA has benefits beyond that which can be obtained with Millad 3988. CaHHPA tends to be insensitive to heat melt temperature, which is a significant advantage. There is less of a problem with migration or plate out when using CaHHPA, and it may be acceptable in retort applications as well. CaHHPA is generally thermally stable, which is a significant advantage.

### Manufacture of Blown Film

Referring to FIG. 1, a blown film may be manufactured. Blown film extrusion 20 is shown in FIG. 1. A molten polymer or resin 22 is made by beginning with a compounded resin (as described in Examples herein), wherein the compounded resin contains various additives as set forth, including nucleating agents, acid scavengers, and the like. Molten polymer or resin 22 is pushed by screw 21 from left to right as shown in FIG. 1, and along the direction of the arrow. Molten polymer 22 passes through screen pack 26, and is heated by heater 28. In other instances, heaters may be provided along the entire length of the extruder block 24. The molten polymer 22 passes through die 29, and beyond mandrel 32. Air line 30 provides compressed air to blow said molten polymer 22 into a blown polymer bubble 36 beyond air ring 34. The air ring 34 controls the cooling of the polymer bubble 36 to make film 42 which is formed. The blown polymer bubble 36 is circular (or tubular), and is seen in a side view in FIG. 1. The ejection of air against the polymer to form a tubular shaped “bubble” of polymer is referred to herein as “blowing” the polymer, and the polymer proceeds upwards as shown in FIG. 1.

The bubble 36 is tube shaped, and is cooled to below T_{c}, crystallization temperature. Then, the polymer is rolled into a flattened tube or wound. The blown polymer bubble 36 passes by guide rolls 38a-b, and through nip rolls 40. The bubble 36 is sealed by nip 40, and thus air cannot easily escape. The bubble 36 acts like a permanent shaping mandrel and provides slight orientation to the film in the transverse direction (TD). The bubble 36 becomes a film 42 that may be passed over a treater bar 44 and rolled among various guide rolls 46a-e to wind-up roll 48. Orientation in the machine direction (i.e. the direction of travel) can be induced by tension from the nip rolls 40.

### Manufacture of Cast Film

In the practice of the invention, it may be possible to make cast film using the novel compositions disclosed herein. Cast film may be made using techniques known in the cast film manufacturing industry, and the invention may apply equally as well to cast film forming techniques. A cast film may be manufactured in which the film comprises a polypropylene polymer or copolymer; and a cycloaliphatic metal salt; and a fatty acid salt, said fatty acid salt having an anion of C₁₂-C₂₂ and a cation, in which the cation is selected from the group consisting of: zinc, calcium, lithium, magnesium and sodium.

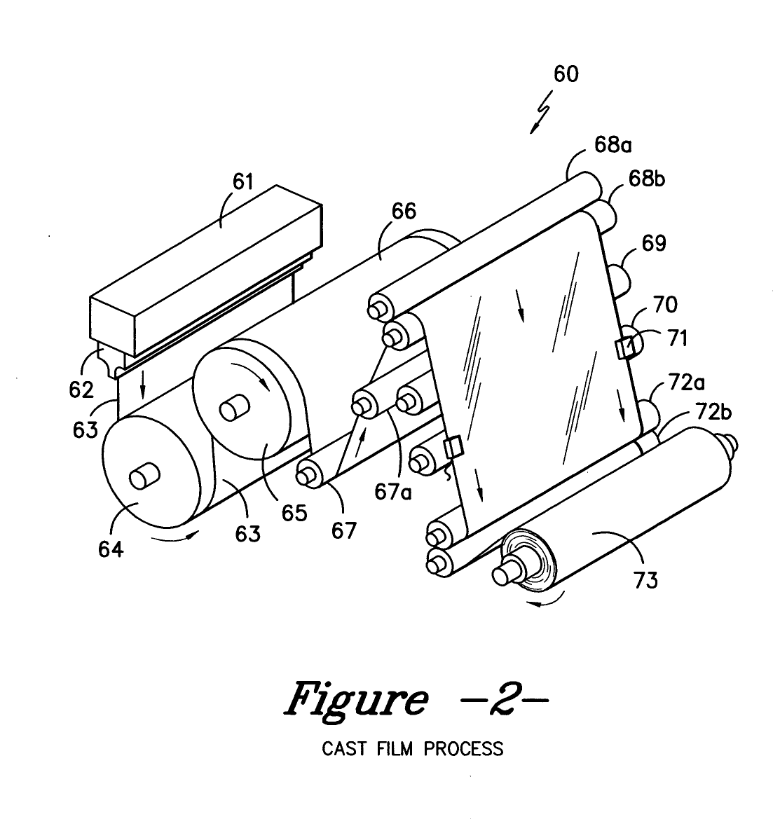

Referring to FIG. 2, a cast film process 60 is shown. A molten polymer emerges from extruder 61 at die 62 in the form of a hot film 63. This hot film 63 is made with a compounded resin (as described in Example 8 herein), wherein the compounded resin contains various additives as set forth, including nucleating agents, acid scavengers, and the like. The molten polymer passes through die 62, forming a sheet or film 63 and then is “cast” as a sheet onto chill rolls 64 and 65 to cool and crystallize into cooled film 66. In many instances, the film 63 will pass over a series of chill rolls in order to fully cool and crystallize the polymer to a temperature below T_{c}, crystallization temperature. The film 66 then may be passed along idler rolls 67 and 67a and between nip rolls 68a-b to powered carrier rolls 69-70. The film may be passed over a treater bar (not shown) and then slit at trimmer 71. The edges of the film 66 are trimmed off by a trimmer as the edge of the film may be of a different thickness than that desired. Trimming also allows for control of the film roll width before passing to nip rolls 72a-b and windup roll 73. The film is wound upon windup roll 73 for storage and transport. Cast and blown film processes obviously differ by the geometry and equipment with which films are made, as shown in a comparison of FIGS. 1 and 2. These differences in mode of extrusion result in differences in the cooling and deformation modes of each type of film, resulting in differences in molecular orientation and thus physical properties of each of the films. The cast film process typically cools at a faster rate than the blown film process resulting in a differences in crystallinity between the two film types. Differences in crystallinity will result in differences in the optical and physical properties between the cast and blown film types. The cast film process produces film having primarily a uniaxial deformation mode, meaning that molecular orientation is primarily in a single direction (referred to herein as “uniaxial molecular orientation”). The blown film process has a biaxial orientation deformation mode, resulting in biaxial molecular orientation. Differences in molecular orientation result in differences in the physical properties of each of the films. Physical property differences can be seen in such properties as modulus and impact properties. A film of less than about 300, or alternately, less than about 100 micrometers may be formed, or in other cases, less than about 70 micrometers. CaHPPA is a very useful cycloaliphatic salt for such cast film applications, and further, a fatty acid salt of zinc stearate is particularly useful. Also, it is noted that cast film may be subjected to a machine direction orientation process wherein the film is reheated and oriented between rolls of varying speeds to provide further machine direction (MD) orientation. This process further affects crystalinity and physical properties.

### Manufacture of Oriented Film

In the practice of the invention, it also may be possible to make oriented films (uniaxially or biaxially) using the novel compositions disclosed herein. Oriented film may be made using techniques known in the film manufacturing industry, and the invention may apply equally as well to oriented film forming techniques. An oriented film may be manufactured in which the film comprises a propylene polymer or copolymer; and a cycloaliphatic metal salt; and a fatty acid salt, said fatty acid salt having an anion of C₁₂-C₂₂ and a cation, in which the cation is selected from the group consisting of: zinc, calcium, lithium, magnesium and sodium.

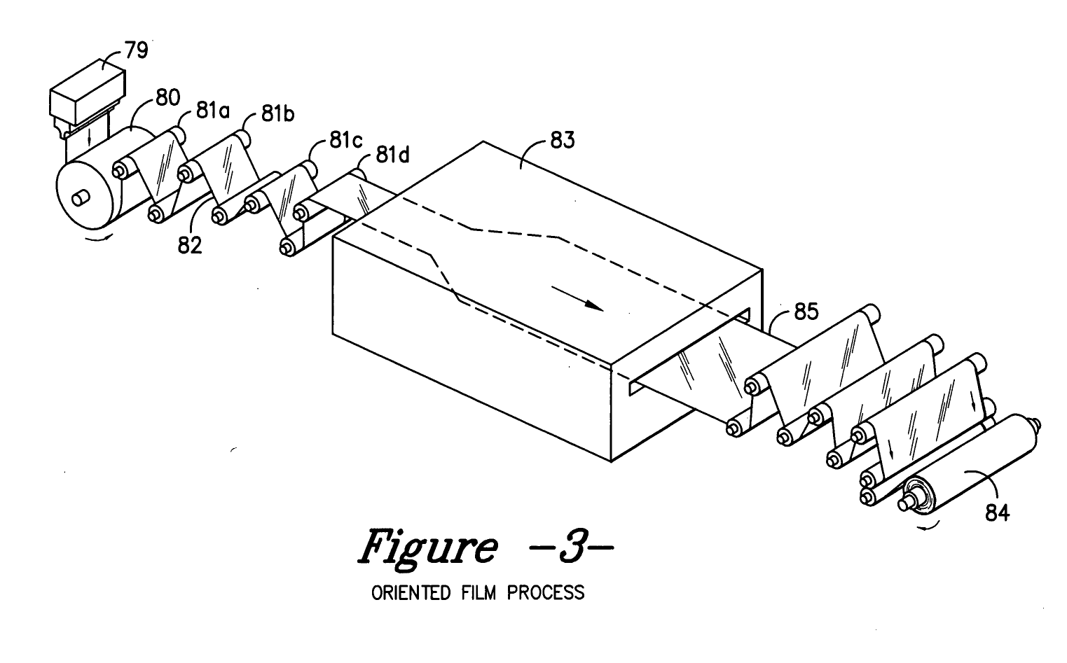

Referring to FIG. 3, in the orientation process, polymer is extruded from a die 79 and made into sheet 82 which is passed over large roll 80 to calendar rolls 81a-d This cooled sheet can be reheated and then oriented in oven 83, or in the machine direction by speed variance between two heated rolls. In this final form a uniaxially oriented machine direction film 84 is manufactured. In the case of biaxially oriented film, the uniaxially oriented film is grasped by tenter hooks and conveyed into a heating oven 83 where it is oriented in the transverse direction. The orientation ratios, stretch speeds, oven and roll temperatures, etc. are independently controlled allowing for a broad range of final film and crystal characteristics including polymer orientations. Oriented film can be manufactured by sequential orientation or by simultaneous orientation.

### Double Bubble Process

In the practice of the invention, it also may be possible to make double bubble films using the novel compositions disclosed herein. A double bubble film may be made using techniques known in the film manufacturing industry, including air or water quench, and the invention may apply equally as well to double bubble film forming techniques. A double bubble film may be manufactured in which the film comprises a propylene polymer or copolymer; and a cycloaliphatic metal salt; and a fatty acid salt, said fatty acid salt having an anion of C₁₂-C₂₂ and a cation, in which the cation is selected from the group consisting of: zinc, calcium, lithium, magnesium and sodium.

Referring to FIG. 4, in the double bubble process, polymer is extruded upward or downward through an annular die 90 and blown in the conventional manner as previously described in connection with FIG. 1. In this process, the film 91 is blown in first blowing apparatus 92, and is normally quenched using chilled air or cold water. This blown tubular film 93 is cooled further to form cool blown film 94, and then may be reheated and reinflated to form a second bubble 95. While it is not mandatory, it is common in the industry to impart machine direction orientation while blowing the first bubble 93, and impart transverse orientation during the formation second bubble 95. As with biaxially oriented films (FIG. 3), the orientation ratios, speeds, temperatures, etc. are independently controlled allowing for a broad range of final film characteristics including polymer and crystal orientations.

### EXAMPLE 1

### Calcium HHPA in Homopolymer Polypropylene Homopolymer (HP)

To a common Homopolymer PP (HP) in the film industry having a density of 0.90 grams per cubic centimeter and a melt flow rate of 2.8 g/10 minutes, 500 ppm of the following Calcium HHPA compound was applied: 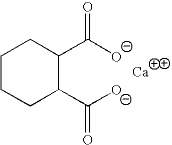
The above compound was physically blended, twin screw compounded, and pelletized. The resultant compounded resin was then made into film of 50 micron in thickness using a standard blown film process with a blow up ratio of 2.0:1.

Haze was measured according to ASTM D 1003 (“Standard Test Method for Haze and Luminous Transmittance of Transparent Plastics”), Procedure A. This testing procedure employs a hazemeter as described in Section 5 of ASTM D 1003, and is considered an industry standard for such measurements.

Internal haze was measured by coating both film surfaces with mineral oil and sandwiching between two glass slides. Haze was then measured on a standard hazemeter. The final value of internal haze subtracts the haze contribution of two glass slides. Surface haze is the difference between total haze and internal haze.

Surface roughness values are the film's root-mean-square peak height as calculated using atomic force microscopy. Gloss measured at 60° reflectance angle with a BYK Gardner micro-TRI-gloss Glossmeter.

The resultant film had the following optical properties:

TABLE I
Optical Properties of HP PP Blown Film

| | Total | Surface | Surface | |
|---|---|---|---|---|
| Sample | Haze (%) | Haze (%) | Roughness (nm) | 60° Gloss |
| Control | 37.9 | 27.1 | 127.3 | 24.0 |
| CaHHPA | 11.7 | 5.3 | 37.0 | 77.3 |
| (500 ppm) | | | | |
| Millad ® 3988 | 14.6 | 8.7 | 42.5 | 64.7 |
| (1000 ppm) | | | | |

Based on the results in Table I, CaHHPA is very effective in reducing the haze of the homopolymer PP blown film, even more effective than Millad® 3988, which is known to be a good commercial clarifier in injection molded PP applications. This is a surprising result. In addition, CaHHPA is very effective in reducing the surface roughness of the film. As a result, surface gloss is dramatically improved, while surface haze is reduced. Higher gloss and lower haze are much desired properties for PP film.

At least one prior art references indicates that reduction of surface haze is a result of using a lower crystallinity amorphous material on the skin. However, the use of Millad® 3988 and Ca HHPA actually increase crystallinity and reduce surface haze. This is an unexpected result.

### EXAMPLE 2

### Calcium HHPA in Random Copolymer Polypropylene (RCP)

To a common Unipol RCP in the industry, having a density of 0.894 grams per cubic centimeter and a melt flow rate of 1.9 g/10 minutes, 500 ppm of CaHHPA was added. The resulting mixture was physically blended, single screw compounded, and pelletized. The compounded resin was then formed into film of 50 micron in thickness using a standard blown film process with a blow up ratio about 2.0:1.

Haze was measured according to ASTM D 1003 (“Standard Test Method for Haze and Luminous Transmittance of Transparent Plastics”), Procedure A. This testing procedure employs a hazemeter as described in Section 5 of ASTM D 1003, and is considered an industry standard for such measurements.

Internal haze was measured by coating both film surfaces with mineral oil and sandwiching between two glass slides. Haze was then measured on a standard hazemeter. The final value of internal haze subtracts haze contribution of two glass slides. Surface haze is the difference between Total haze and Internal Haze.

Surface roughness values are the film's root-mean-square peak height as calculated using atomic force microscopy. Gloss measured at 60° reflectance angle with a BYK Gardner micro-TRI-gloss Glossmeter.

The resultant film had the following optical properties:

TABLE II
Optical Properties of RCP PP Blown Film

| | Total | Surface | Surface | |
|---|---|---|---|---|
| Sample | Haze (%) | Haze (%) | Roughness (nm) | 20° Gloss |
| Control | 47.7 | 43.2 | 113 | 12.6 |
| CaHHPA | 8.7 | 6.9 | 46.4 | 37.5 |
| (500 ppm) | | | | |
| Millad ® 3988 | 14.6 | 12.7 | 61.3 | 31.7 |
| (1500 ppm) | | | | |

As shown in Table II. above, the addition of CaHHPA improves the optical properties of a standard random copolymer blown film (an 81% reduction in total haze versus the 69% reduction observed with Millad 3988). These results are unexpected as it has previously been believed that Millad 3988 provided the best optical properties possible In injection molding applications. As such, it is surprising that in blown film applications, low loadings of CaHHPA provide superior haze and gloss values compared to Millad 3988, which is a known for polypropylene clarification in injection molding. This improvement in haze and gloss provides an optically enhanced film useful in the packaging industry.

### EXAMPLE 3

### Calcium HHPA in Various Types of RCP Polyproplyene

Polypropylene (PP) can be manufactured in many different ways. To Spheripol and Unipol reactor flake polyproplyene (PP), a mixture of 1000 ppm of Calcium HHPA and a stabilization package (500 ppm Irganox® 1010, 1000 ppm Irgafos®168, and 800 ppm zinc stearate) were added. The resulting mixtures were physically blended, single screw compounded, and pelletized. The resultant compounded resin was then made into film of approximately 25 micron in thickness using a standard blown film process with a blow up ratio of approximately 2.0:1.

TABLE III
Performance of CaHHPA in 2.0 MFR Unipol polypropylene

| | | | 1% Secant Modulus |
|---|---|---|---|
| Formulation | Haze (%) | 45° Gloss | (MPa) MD/TD |
| Control | 28.8 | 42.7 | 82.3/92.9 |
| Millad ® 3988 | 7.41 | 80.1 | 107.0/106.0 |
| CaHHPA | 8.74 | 82.4 | 114.0/114.0 |

TABLE IV
Performance of CaHHPA in 2.0 MFR Spheripol polypropylene

| | | | 1% Secant Modulus (MPa) |
|---|---|---|---|
| Formulation | Haze (%) | 45° Gloss | MD/TD |
| Control | 7.08 | 69.3 | 99.0/94.4 |
| Millad ® 3988 | 3.80 | 86.2 | 110.0/95.7 |
| CaHHPA | 1.60 | 97.4 | 104.5/103.9 |

CaHHPA can be used to clarify PP of various types, like PP from a Unipol process or a Spheripol process. As a result of using CaHHPA, the stiffness of the film increases, shown as modulus in Table III and IV.

### EXAMPLE 4

### Effect of Acid Scavenger Type Upon Optical Properties of PP Blown Films

To a common PP in the industry a mixture of (1000 ppm) Calcium HHPA and a stabilization package (500 ppm Irganox® 1010, 1000 ppm Irganox® 168, and 800 ppm of an acid scavenger) were added. The type of acid scavenger was varied to include Zinc Stearate (ZnSt), Calcium Stearate (CaSt), Sodium Stearate (NaSt), Magnesium Stearate (MgSt), Lithium Stearate (LiSt), and Potassium Stearate (KSt). The resulting mixtures were physically blended, single screw compounded, and pelletized. The resultant compounded resins were then made into film of approximately 50 micron thickness using a standard blown film process. It was discovered that the use of ZnSt provided unexpected and significant benefits in. % Haze as compared to the other stearate compounds tested. The resultant films had the following properties:

TABLE VI
Comparison of Different Stearates With Calcium HHPA

| Acid Scavenger | % Haze | 45° Gloss |
|---|---|---|
| No Clarifier + CaSt | 19.9 ± 0.66 | 36.9 ± 6.0 |
| CaHHPA + No Stearate | 7.21 ± 0.55 | 75.6 ± 2.8 |
| CaHHPA + CaSt | 5.14 ± 0.27 | 83.5 ± 1.6 |
| CaHHPA + ZnSt | 3.24 ± 0.35 | 87.8 ± 1.4 |
| CaHHPA + NaSt | 3.45 ± 0.35 | 89.2 ± 0.6 |
| CaHHPA + MgSt | 3.27 ± 0.23 | 90.2 ± 1.0 |
| CaHHPA + LiSt | 3.69 ± 0.13 | 82.5 ± 2.2 |
| CaHHPA + KSt | 4.76 ± 0.54 | 83.0 ± 2.2 |
| Millad ® 3988 + Ca St | 4.72 ± 0.31 | 50.6 ± 7.2 |

These results indicate that incorporating a stearate into a PP film composition is beneficial. An unexpected benefit is realized when compounding CaHHPA with the acid scavenger, ZnSt. In this study, the combination of CaHHPA and ZnSt outperformed similar compositions containing Millad 3988, and provided the lowest haze, i.e. 3.24%, in a random copolymer (RCP) polypropylene (PP).

### EXAMPLE 5

### Effect of HHPA Counter Ion on Optical Properties of PP Blown Films

To a common RCP polypropylene in the industry, a mixture of HHPA salt (1000 ppm) and a stabilization package (500 ppm Irganox® 1010, 1000 ppm Irganox® 168, and 800 ppm zinc stearate) were added. For comparison purposes, additional samples containing Millad 3988 at 1000 ppm and a stabilization package (500 ppm Irganox® 1010, 1000 ppm Irganox® 168, and 800 ppm calcium stearate) were created.

The type of HHPA salt was varied as a function of its counter ion. The counter ions included Zinc, Calcium, and Magnesium. The resulting mixtures were physically blended, single screw compounded, and pelletized. The resultant compounded resins were then made into film of approximately 50 micron thickness using a standard blown film process.

Haze was measured according to ASTM D 1003 (“Standard Test Method for Haze and Luminous Transmittance of Transparent Plastics”), Procedure A. This testing procedure employs a hazemeter as described in Section 5 of ASTM D 1003, and is considered an industry standard for such measurements.

The resultant films had the following properties:

TABLE V
Zinc Stearate Employed with Various HHPA SALTS

| HHPA SALT | % Haze | 45° Gloss |
|---|---|---|
| NONE | 21.0 ± 1.89 | 33.6 ± 8.2 |
| Zinc HHPA | 21.2 ± 0.68 | 41.5 ± 3.4 |
| Magnesium HHPA | 13.3 ± 1.13 | 37.6 ± 7.0 |
| Calcium HHPA | 2.44 ± 0.27 | 92.3 ± 1.2 |
| Millad ® 3988 (1000 ppm) | 3.02 ± 0.04 | 90.4 ± 1.6 |

Surprisingly, the calcium HHPA showed an unexpected improvement in film haze and gloss when compared to other counter ions in this polypropylene blown film application. Haze and Gloss performance exceeds that of the Millad 3988. This is an unexpected result, and likely is quite beneficial to the film industry.

### EXAMPLE 6

### Optical Properties of PP Films Using Various Clarifiers

To better understand the performance of CaHHPA, various potential clarifiers were added to a common random copolymer PP in the industry. The resulting mixtures were physically blended, single screw compounded, and pelletized. The resultant compounded resins were then made into film of approximately 25 micron thickness using a standard blown film process. The resultant film had the following optical properties:

TABLE VII
Nucleating Agent Type versus Haze and Clarity

| Additive | Additive Concentration (ppm) | % Haze |
|---|---|---|
| Control | 0 | 27.1 |
| Millad ® 3988 | 1000 | 2.9 |
| NA-11 ™ | 1000 | 5.8 |
| (a bis phenol phosphate) | | |
| Sodium Benzoate | 1000 | 24.6 |
| sodium, bicyclo[2.2.1]heptane | 1000 | 8.9 |
| dicarboxylate | | |
| Ca HHPA + ZnSt | 1000 | 3.2 |

CaHHPA and Millad® 3988 are the best clarifier among all tested. All clarifiers have improved haze when compared to control, and only sodium benzoate has very slight improvement.

### EXAMPLE 7

### Performance in Multi-Layer Blown Films

To a common PP in the industry, a stabilization package (500 ppm Irganox® 1010, 1000 ppm Irganox® 168, and 800 ppm of an acid scavenger) were added. Two samples were manufactured, one did not contain any additional nucleators, the “Control”, and the other contained 1000 ppm CaHHPA. The resulting mixtures were physically blended, single screw compounded, and pelletized. The resultant compounded resins were then made into thermoforming films with the following 7-layer structure:

PP/tie/Nylon/EVOH/Nylon/tie/PP

The final films were coextruded to approximately 127 micron (5.0 mil) thickness using a standard multi-layer blown film process. The resultant films had the following properties:

TABLE VIII
Clarification of Multi-layer Blown Films

Additive in Skin Layer:

| | Control RCP | CaHHPA |
|---|---|---|
| Haze (%) | 29.1 ± 0.22 | 13.0 ± 0.44 |
| 45° Gloss | 52.9 ± 0.99 | 64.7 ± 1.7 |
| MD/TD Tear (gf) | 166.4/170.1 | 195.8/229.1 |
| MD/TD 1% Secant Modulus | 97.1/97.5 | 115.7/99.5 |

In multi-layer films, the addition of CaHHPA shows a 55% reduction in haze and improves gloss. It is also noted that the addition of CaHHPA has a positive effect on physical properties, improving bi-directional tear and 1% secant modulus. Improvements in these properties could potentially lead to down-gauging, reducing film thickness. A reduction in raw material usage can lead to cost savings, a common need in the flexible packaging industry. The property improvements seen in these films could be realized in many other multi-layer film constructions. The additive may be effective in skin and cure layers, and this example is in no way a limit on the spirit and scope of this invention. Many different film constructions could be employed other than those specific constructions showed herein.

To further analyze the performance of CaHHPA in multi-layer films, a secondary evaluation was completed to compare the performance of CaHHPA to Millad 3988, an industry leading clarifying agent. In this trial a mixture of clarifying agent—Sample 1=Calcium HHPA (1000 ppm) and Sample 2=Millad 3988 (1000 ppm)—and a stabilization package (500 ppm Irganox® 1010, 1000 ppm Irganox® 168, and 800 ppm of an acid scavenger) were added to a common RCP PP in the industry. The resulting mixtures were physically blended, single screw compounded, and pelletized. The resultant compounded resins were then made into films.

Clarified PP/tie/Nylon/EVOH/Nylon/tie/Clarified PP

The final films were coextruded to approximately 175 micron thickness using a standard multi-layer blown film process. The resultant films had the following properties:

TABLE XII
Clarification of Multi-layer Blown Films

Additive in Skin Layer:

| | Millad 3988 | CaHHPA |
|---|---|---|
| Thickness (mil) | 6.5 | 7.0 |
| Haze (%) | 9.37 | 7.38 |
| 45° Gloss | 75.0 | 86.0 |
| MD/TD Tear (gf) | 1930/1940 | 2270/1990 |
| 1% Secant Modulus MPa MD/TD | 388.6/398.6 | 468.9/426.4 |

It was surprisingly discovered that the use of CaHHPA provided unexpected and significant benefits in % Haze as compared to Millad 3988.

### EXAMPLE 8

### Effect of CaHHPA in Polypropylene made by Cast Film Process

To a common random copolymer PP in the film industry, a mixture of 1000 ppm of Calcium HHPA and a stabilization package (500 ppm Irganox® 1010, 1000 ppm Irganox® 168, and 800 ppm of an acid scavenger) were added. The resulting mixture was physically blended, single screw compounded, and pelletized. The resultant compounded resin was then made into film of approximately 45 micron thickness using a standard cast film process. The resultant films had the following properties.

TABLE VII
Clarification of PP in the Cast Film Process

| | | Ca HPPA Clarified Film |
|---|---|---|
| Resin | Unclarified Film % Haze | % Haze |
| RCP | 1.61 | 0.88 |

The addition of CaHHPA provided a 45% reduction in haze in the cast film process. It is unexpected that CaHHPA can further enhance the optical performance of quench-cooled films.

### EXAMPLE 9

### Performance in Biaxially Oriented Films (BOPP)

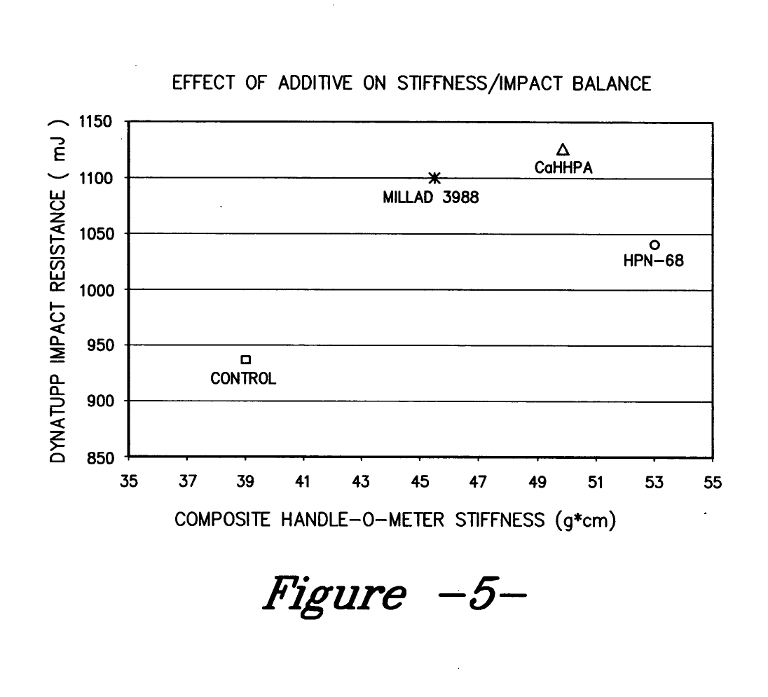

The following nucleating/clarifying agents were added to a common 2.8 MFR homopolymer PP in the film industry: Millad 3988 (1500 ppm), CaHHPA (500 ppm), and Hyperform HPN-68L (400 ppm). The resulting mixtures were physically blended, twin screw compounded, and pelletized. The resultant compounded resins were then made into biaxially oriented films on a Brückner KARO Lab Stretcher. A designed experiment evaluating oven temperature and sequential stretch ratios demonstrated that the tested nucleating/clarifying agents have a statically significant affect on the balance of a film rigidity and impact properties. In the case of using Ca HHPA, a significant improvement was observed (see FIG. 5). Films were subjected to impact testing conducted in accordance with ASTM D 3763-00. A Dynatup instrumented impact tester with an impact velocity of 200 m/min and sample diameter of 60 mm was used. Film rigidity was measured using a handle-o-meter in accordance with ASTM D2923-95. FIG. 5 illustrates performance of these films in terms of impact resistance. CaHHPA shows the best impact resistance and the second best stiffness, while sodium, bicyclo[2.2.1]heptane dicarboxylate shows the best stiffness. All nucleating/clarifying agents show improved impact/stiffness balance than the control sample. Improving the impact/stiffness balance is a desired property of the film industry.

### EXAMPLE 10

### Sodium, Bicyclo[2.2.1]Heptane Dicarboxylate in Random Copolymer (RCP) PP

To a common RCP in the industry, various formulations of sodium, bicyclo[2.2.1]heptane dicarboxylate were evaluated. In addition to a nucleating agent, a stabilization package (500 ppm Irganox® 1010, 1000 ppm Irganox® 168, 800 ppm CaSt) was added to the formulation. The resulting mixture was physically blended, single screw compounded, and pelletized. The compounded resin was then formed into film of 50 micron in thickness using a standard blown film process with a blow up ratio about 2.0.

Haze was measured according to ASTM D 1003 (“Standard Test Method for Haze and Luminous Transmittance of Transparent Plastics”), Procedure A. This testing procedure employs a hazemeter as described in Section 5 of ASTM D 1003, and is considered an industry standard for such measurements.

Gloss measured at 60° reflectance angle with a BYK Gardner micro-TRI-gloss Glossmeter.

The resultant film had the following optical properties:

TABLE X
Optical Properties of RCP PP Blown Film

| Sample | Loading | Total Haze (%) | 60° Gloss |
|---|---|---|---|
| Control | | 19.5 | 54 |
| sodium, bicyclo[2.2.1]heptane | 1000 ppm | 8.9 | 90 |
| dicarboxylate | | | |
| sodium, bicyclo[2.2.1]heptane | 750 ppm/ | 5.5 | 95 |
| dicarboxylate + silica | 750 ppm | | |
| sodium, bicyclo[2.2.1]heptane | 1250 ppm/ | 3.7 | 97 |
| dicarboxylate + silica | 1250 ppm | | |

Sodium, bicyclo[2.2.1]heptane dicarboxylate can also clarify PP blown film, reducing from about 20% control haze to about 9% for the clarified one. When blending with nano sized silica like Aerosil® R972, haze can be further decreased to 5.5% and 3.7%. Gloss of clarified formulations is also highly improved when compared to control sample.

### FURTHER DETAILED DESCRIPTION

It is important to understand that film properties like haze, gloss, modulus, etc are highly dependant on the formulation and experimental conditions. It is only reasonable to compare data within the same experiment, as shown in each individual example. In all cases, CaHHPA improves PP film in various aspects like optical and physical properties in blown and cast PP film, and physical properties in BOPP. In addition, sodium, bicyclo[2.2.1]heptane dicarboxylate also improves the optical and physical properties of PP film, particularly when it is combined with silica, preferably, nano sized silica.

It is understood by one of ordinary skill in the art that the present discussion is a description of exemplary embodiments only, and is not intended as limiting the broader aspects of the present invention, which broader aspects are embodied in the exemplary constructions. The invention is shown by example in the appended claims.

1. A film comprising:
(a) polypropylene,
(b) a nucleating agent in the form of a cycloaliphatic metal salt;
(c) a fatty acid salt, said fatty acid salt comprising a C₁₂-C₂₂ anion and a cation, said cation selected from the group consisting of: zinc, magnesium, sodium, lithium, and potassium.

2. The film of claim 1 wherein said cycloaliphatic metal salt comprises an anion and a calcium cation.

3. The film of claim 1 wherein said cycloaliphatic metal salt comprises Ca HHPA.

4. The film of claim 1, wherein said cation of said fatty acid salt comprises zinc.

5. The film of claim 1 wherein said fatty acid salt (c) comprises zinc stearate.

6. The film of claim 1 wherein said film additionally comprises silica.

7. The film of claim 6 wherein said silica has an average particle size of less than about 1 micrometer.

8. The film of claim 1, wherein said film is made by a blowing process.

9. The film of claim 1, wherein said film is made by a cast process.

10. The film of claim 1, wherein said film is made by an oriented film making process.

11. The film of claim 1, wherein said film is less than about 300 micrometers in thickness.

12. The film of claim 9 wherein the measured percent haze of said film at a thickness of 50 microns is less than about 5% haze units.

13. The film of claim 1, wherein said cycloaliphatic metal salt is provided as CaHHPA, said CaHHPA being provided in said film at a use level of less than about 2000 ppm.

14. The film of claim 1, further wherein said cycloaliphatic metal salt comprises sodium, bicyclo[2.2.1]heptane dicarboxylate provided at a concentration level of less than about 2000 ppm.

15. A method of making a polypropylene film, said method comprising the steps of:
(a) providing a molten polyolefin resin, said resin comprising a nucleating agent compound of a cycloaliphatic salt and a fatty acid salt;
(b) extruding said molten polyolefin resin;
(c) blowing air through said molten polyolefin resin to form a bubble; and
(d) cooling said bubble to form a film.

16. The method of claim 15, wherein the said cycloaliphatic salt comprises CaHHPA.

17. The method of claim 15 wherein zinc stearate is applied to said polypropylene resin prior to the said blowing step.

18. The method of claim 15, wherein the said cycloaliphatic salt is sodium, bicyclo[2.2.1]heptane dicarboxylate.

19. The method of claim 15 wherein said film is formed at a thickness of less than about 300 micrometers.

20. The method of claim 15 polyolefin resin comprises polypropylene.

21. A method of making a polypropylene cast film, said method comprising the steps of:
(a) providing a molten polypropylene resin, said resin comprising a nucleating agent compound of a cycloaliphatic salt and a fatty acid salt;
(b) extruding said molten polyolefin resin;
(c) casting said resin to form a sheet; and
(d) cooling said sheet to form a film.

22. A method of making an oriented polypropylene film, said method comprising the steps of:
(a) providing a molten polypropylene resin, said resin comprising a nucleating agent compound of a cycloaliphatic salt and a fatty acid salt;
(b) extruding said molten polyolefin resin;
(c) forming said resin into a sheet;
(d) cooling said sheet, and
(e) reheating said sheet to orient said polypropylene, thereby forming an oriented polypropylene film.
